(19) United States
(12) Patent Application Publication
(10) Pub. No.: US 2025/0344083 A1
(43) Pub. Date: Nov. 6, 2025

(54) MEASUREMENT SAMPLING BASED ON NETWORK ENTITY MOBILITY

(71) Applicant: QUALCOMM Incorporated, San Diego, CA (US)

(72) Inventors: Jun ZHU, San Diego, CA (US); Kang GAO, San Diego, CA (US); Raghu Narayan CHALLA, San Diego, CA (US)

(21) Appl. No.: 18/654,428

(22) Filed: May 3, 2024

(51) Int. Cl. H04W 24/08

(52) U.S. Cl. CPC H04W 24/08

(57) ABSTRACT

Methods, systems, and devices for wireless communications are described. A user equipment (UE) receives a first synchronization signal block (SSB) from a network entity, where the first SSB is received via a first SSB beam, and where communication between the UE and the network entity is based on the SSB. The UE obtains measurements of one or more second SSBs while the UE is in communication with the network entity, where the one or more second SSBs are received via respective second SSB beams, and where a target SSB measurement periodicity for collection of the measurements of the one or more second SSBs via the respective second SSB beams is based on a mobility associated with the UE.

### INTRODUCTION

The following relates to wireless communications that pertain to measurement sampling based on mobility of a network entity (e.g., a user equipment).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless processes may include a UE that measures a communication quality with a network entity over one or more beams, for example, by beam sweeping. In some examples, the period for measuring the communication quality over the one or more beams may be too large or too small, resulting in inaccurate communication quality determinations and/or increased power consumption at the UE.

### SUMMARY

The described techniques relate to improved methods, systems, devices, and apparatuses that support measurement sampling based on network entity mobility. Generally, the described techniques provide that a user equipment (UE) may measure one or more synchronization signal blocks (SSBs) via respective SSB beams based on a mobility associated with the UE. For example, the UE may initially measure an SSB from a network entity via a beam during an initial measurement periodicity. The UE may move or be mobile, such that additional beams may provide better communication quality between the network entity and the UE, and the UE may subsequently measure the additional SSBs via the respective additional SSB beams. The UE may obtain the measurements of the additional SSBs during a target SSB measurement periodicity via the respective additional SSB beams. For example, the initial measurement periodicity may no longer be suitable based on the mobility of the UE. Accordingly, the UE may adjust the SSB measurement periodicity based on the change in mobility of the UE. The measurement periodicity may be adjusted based on a scaling factor, such that the initial measurement periodicity is scaled (e.g., increased or decreased) for the mobility to provide the target SSB measurement periodicity.

A method for wireless communication by a first network entity is described. The method may include receiving a first SSB from a second network entity, where the first SSB is received via a first SSB beam, and where communication between the first network entity and the second network entity is based on the SSB and obtaining measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity.

A first network entity for wireless communication is described. The first network entity may include one or more memories storing processor executable code, and one or more processors coupled with the one or more memories. The one or more processors may individually or collectively be operable to execute the code to cause the first network entity to receive a first SSB from a second network entity, where the first SSB is received via a first SSB beam, and where communication between the first network entity and the second network entity is based on the SSB and obtain measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity.

Another first network entity for wireless communication is described. The first network entity may include means for receiving a first SSB from a second network entity, where the first SSB is received via a first SSB beam, and where communication between the first network entity and the second network entity is based on the SSB and means for obtaining measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity.

A non-transitory computer-readable medium storing code for wireless communication is described. The code may include instructions executable by one or more processors to receive a first SSB from a second network entity, where the first SSB is received via a first SSB beam, and where communication between the first network entity and the second network entity is based on the SSB and obtain measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity.

Some examples of the method, first network entities, and non-transitory computer-readable medium described herein may further include operations, features, means, or instructions for adjust the target SSB measurement periodicity based on a change in the mobility associated with the first network entity.

In some examples of the method, first network entities, and non-transitory computer-readable medium described herein, the mobility may be associated with a scaling factor and the target SSB measurement periodicity may be based on application of the scaling factor to a current SSB measurement periodicity.

Some examples of the method, first network entities, and non-transitory computer-readable medium described herein may further include operations, features, means, or instructions for determine the scaling factor based on a detection status of the one or more second SSBs, where the detection status includes detected SSBs and undetected SSBs, and where the current SSB measurement periodicity may be indicated to the first network entity for detected SSBs, and the current SSB measurement periodicity may be estimated by the first network entity for undetected SSBs.

In some examples of the method, first network entities, and non-transitory computer-readable medium described herein, the scaling factor may be a per-SSB UE scaling factor based on the detection status of the one or more second SSBs being detected SSBs.

In some examples of the method, first network entities, and non-transitory computer-readable medium described herein, the per-SSB UE scaling factor may be equal to a maximum value of one or a value of a mathematical floor function of a dwell time associated with a respective SSB of the one or more second SSBs divided by a quantity of the second SSB beams used for scheduling and the dwell time includes a time in which the first network entity communicates using the respective SSB.

In some examples of the method, first network entities, and non-transitory computer-readable medium described herein, the scaling factor may be a minimum value of a per-SSB UE scaling factor or a per-SSB network entity scaling factor based on a detection status of the one or more second SSBs being undetected SSBs.

In some examples of the method, first network entities, and non-transitory computer-readable medium described herein, the per-SSB UE scaling factor may be equal to a minimum value of one or a value of a mathematical floor function of a dwell time associated with a respective SSB of the one or more second SSBs divided by a quantity of the second SSB beams and the dwell time includes a time in which the first network entity communicates using the respective SSB.

In some examples of the method, first network entities, and non-transitory computer-readable medium described herein, the per-SSB network entity scaling factor may be equal to a maximum value of one or a value of a mathematical floor function of a dwell time associated with a respective SSB of the one or more second SSBs divided by a quantity of the second SSB beams and the dwell time includes a time in which the first network entity communicates using the respective SSB.

In some examples of the method, first network entities, and non-transitory computer-readable medium described herein, the current SSB measurement periodicity may be estimated by the first network entity for undetected SSBs based on using a cell timing and a timing offset associated with each of the undetected one or more second SSBs.

### BRIEF DESCRIPTION OF THE DRAWINGS

FIG. 1 shows an example of a wireless communications system that supports measurement sampling based on network entity mobility in accordance with one or more aspects of the present disclosure.

FIG. 2 shows an example of a wireless communications system that supports measurement sampling based on network entity mobility in accordance with one or more aspects of the present disclosure.

FIG. 3 shows an example of a process flow that supports measurement sampling based on network entity mobility in accordance with one or more aspects of the present disclosure.

FIGS. 4 and 5 show block diagrams of devices that support measurement sampling based on network entity mobility in accordance with one or more aspects of the present disclosure.

FIG. 6 shows a block diagram of a communications manager that supports measurement sampling based on network entity mobility in accordance with one or more aspects of the present disclosure.

FIG. 7 shows a diagram of a system including a device that supports measurement sampling based on network entity mobility in accordance with one or more aspects of the present disclosure.

FIGS. 8 and 9 show flowcharts illustrating methods that support measurement sampling based on network entity mobility in accordance with one or more aspects of the present disclosure.

### DETAILED DESCRIPTION

Some wireless processes may include a user equipment (UE) that measures a communication quality with a network entity over one or more beams, for example, by beam sweeping and measuring one or more synchronization signal blocks (SSBs). In some examples, an initial SSB measurement periodicity for measuring the communication quality over the one or more beams may be too large or too small, resulting in inaccurate communication quality determinations and/or increased power consumption at the UE. For example, as a UE moves or is mobile, the communication quality between the UE and the network entity may change, additional beams to use for the communication may be available and may provide better communication quality, or both.

As discussed herein, the UE may measure one or more SSBs via respective SSB beams based on a mobility associated with the UE. For example, the UE may initially measure an SSB from a network entity via a beam. The UE may move or be mobile, such that additional beams may provide better communication quality between the network entity and the UE, and the UE may subsequently measure the additional SSBs via the respective additional SSB beams. The UE may obtain the measurements of the additional SSBs during a target SSB measurement periodicity via the respective additional SSB beams. For example, the initial periodicity may no longer be suitable based on the mobility of the UE. Accordingly, the UE may adjust the target SSB measurement periodicity based on the change in mobility of the UE. The measurement periodicity may be adjusted based on a scaling factor, such that the initial measurement periodicity is scaled (e.g., increased or decreased) for the mobility to provide the target SSB measurement periodicity. The target SSB measurement periodicity based on mobility of the UE may result in efficient and more accurate determinations of communication quality between the UE and the network entity over the measured beams, reduced power consumption at the UE by reducing unnecessary measurement periods, or both. As an example, the UE mobility, which may trigger the change in the measurement periodicity, may be either translational or rotational. A dwell time of the UE for a given SSB beam (e.g., an amount of time the UE remains on a specific SSB beam) may be indicative of the UE mobility.

Aspects of the disclosure are initially described in the context of wireless communications systems. Aspects of the disclosure are further illustrated by and described with reference to apparatus diagrams, system diagrams, and flowcharts that relate to measurement sampling based on network entity mobility.

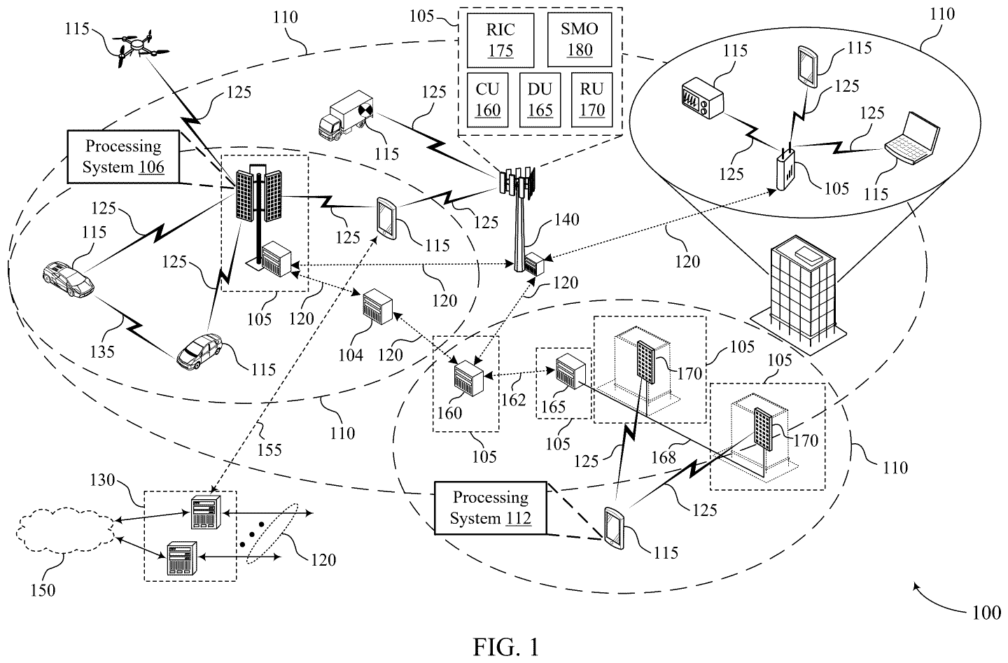

FIG. 1 shows an example of a wireless communications system 100 that supports measurement sampling based on network entity mobility in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an FI AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions.

Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the wireless communications system 100 may include a UE 115 that measures a communication quality with the network entity 105 over one or more beams, for example, by beam sweeping and measuring one or more SSBs. In some examples, an initial SSB measurement periodicity for measuring the communication quality over the one or more beams may become too large or too small, resulting in inaccurate communication quality determinations and/or increased power consumption at the UE 115. For example, as the UE 115 moves or is mobile, the communication quality between the UE 115 and the network entity 105 may change, additional beams to use for the communication may be available and may provide better communication quality, or both.

As discussed herein, the UE 115 may measure one or more additional SSBs via respective additional SSB beams based on a mobility associated with the UE 115. For example, the UE 115 may initially measure an SSB from the network entity 105 via a beam. The UE 115 may move or be mobile, such that additional beams may provide better communication quality between the network entity and the UE 115, and the UE 115 may subsequently measure the additional SSBs via the respective additional SSB beams. The UE 115 may obtain the measurements of the additional SSBs during a target SSB measurement periodicity via the respective additional SSB beams. For example, the initial periodicity may no longer be suitable based on the mobility of the UE 115. Accordingly, the UE 115 may adjust the target SSB measurement periodicity based on the change in mobility of the UE 115. The measurement periodicity may be adjusted based on a scaling factor, such that the initial measurement periodicity is scaled (e.g., increased or decreased) for the mobility to provide the target SSB measurement periodicity. The target SSB measurement periodicity based on mobility of the UE 115 may result in efficient and more accurate determinations of communication quality between the UE 115 and the network entity 105 over the measured beams, reduce power consumption at the UE 115 by reducing unnecessary measurement periods, or both.

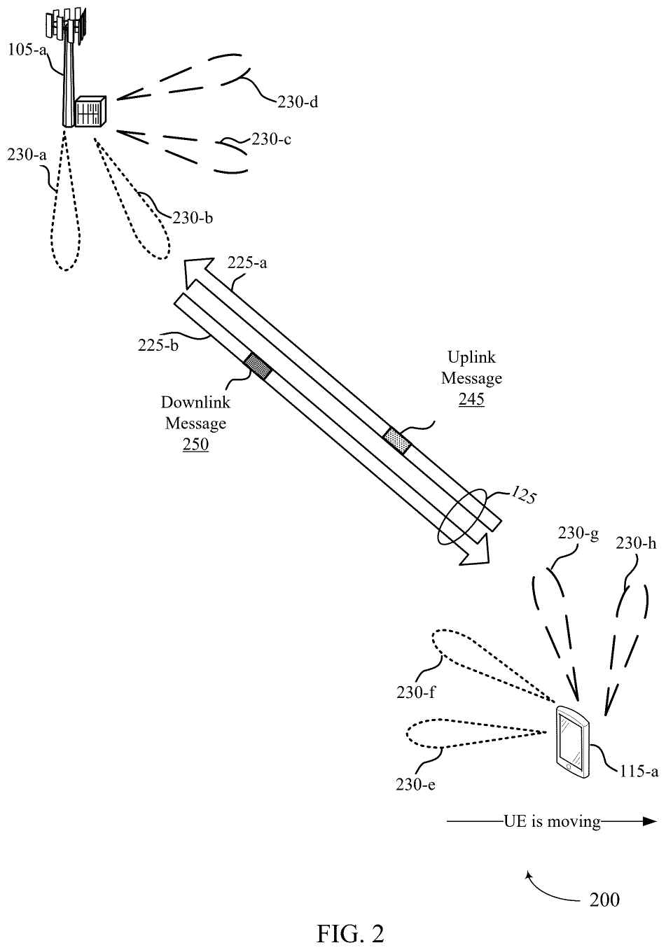

FIG. 2 shows an example of a wireless communications system 200 that supports measurement sampling based on network entity mobility in accordance with one or more aspects of the present disclosure. The wireless communications system 200 may implement aspects of or may be implemented by aspects of the wireless communications system 100. For example, the wireless communications system 200 includes a UE 115-a and a network entity 105-a, which may be examples of a UE 115 and a network entity 105 described with respect to FIG. 1. The techniques described herein may apply to beams at the network entity 105-a and/or the UE 115-a.

In the wireless communications system 200, measurement of SSBs on beams may be based on mobility of the UE 115-a, for example, based on a rotation or a translation of the UE 115-a. For example, the network entity 105-a may communicate SSBs to the UE 115-a over a first beam 230-a, a second beam 230-b, a third beam 230-c, and/or a fourth beam 230-d. The UE 115-a may communicate with the network entity 105-a using a fifth beam 230-c, a sixth beam 230-f, a seventh beam 230-g, and/or an eighth beam 230-h, for example, based on location of the UE 115-a with respect to the network entity 105-a and/or an SNR. For example, the network entity 105-a may communicate SSBs to the UE 115-a over the first beam 230-a and the second beam 230-b, and the UE 115-a may receive signaling and SSBs, measure the SSBs, or may otherwise communicate over the fifth beam 230-e and sixth beam 230-f (as indicated by the short-dashed line). However, as the UE 115-a is moving, the UE 115-a may rotate (e.g., when communicating in frequency ranges of FR2), resulting in a UE side beam switch. The side beam switch may be associated with a relatively faster side beam sweeping (e.g., measurement periodicity) in order to track the best (e.g., greatest SNR) UE beam (e.g., when present measurements are below a threshold) and the UE 115-a may rapidly switch beams due to mobility of the UE 115-a.

In another example, the mobility of the UE 115-a may result in a UE translation (e.g., when communicating in frequency ranges of FR1 and/or FR2). The translation may result in a network entity 105-a and UE 115-a side beam switch. The side beam switch may be associated with a relatively faster side beam sweeping (e.g., measurement periodicity) in order to track the best UE beam (e.g., when present measurements are below a threshold) and the UE 115-a may rapidly switch beams due to mobility of the UE 115-a. In such examples, measurements on SSBs may be sampled in a manner resulting in a tradeoff between tracking and power saving and that is greater than a tradeoff threshold.

In particular, the UE 115-a may initially detect SSBs over the first beam 230-a and the second beam 230-b, and the first beam 230-a may be the serving beam. As the UE 115-a moves, the second beam 230-b may become the serving beam. The third beam 230-c and the fourth beam 230-d (e.g., additional SSB beams) may not be detected initially. In such examples, the UE 115-a may continue using the second beam 230-b as the serving network entity beam until a search for the third beam 230-c and the fourth beam 230-d occurs. For example, in a first mode (e.g., normal or initial mode), the search periodicity for performing the beam sweep or measurements may be a large period. Accordingly, the UE 115-a may not find the new beams (e.g., the third beam 230-c and/or the fourth beam 230-d) efficiently, resulting in reduced communication quality or a communication link drop by using the first beam 230-a and the second beam 230-b. In some examples, the UE 115-a may enter a second mode or a panic mode, for example, when the SNR is below a threshold for the presently used or detected beams (e.g., the first beam 230-a and the second beam 230-b). In the panic mode, the search may be faster and the periodicity may be reduced. However, this mode may be triggered based on the SNR threshold (e.g., SNR is less than −6 decibels (dB)), for example, rather than based on additional beam options. Waiting until the SNR falls below the SNR threshold may result in inefficient power consumption at the UE 115-a, reduced communication quality, and inefficient or inaccurate tracking on available beams for communication between the UE 115-a and the network entity 105-a.

As discussed herein, the UE 115-a may, on each of one or more detected SSBs (e.g., detected on either a secondary cell (SCell) and an (NCell)), perform SSB measurements based on a target periodicity including the product of a scaling factor and the initial SSB periodicity (e.g., the scaling_factor_ue_per_ssb*SSBs periodicity). The scaling factor may be based on a detection of the SSBs (e.g., detected or undetected SSBs for the respective beams).

For detected additional SSBs, the scaling factor may be a per-SSB UE scaling factor based on detecting the additional SSBs, such as the SSBs communicated over the third beam 230-c and the fourth beam 230-d. In such examples, the per-SSB UE scaling factor may be equal to a maximum value of one or a value of a mathematical floor function of a dwell time (e.g., time spent on a given SSB, such as using a current or serving beam) associated with a respective SSB of the one or more second SSBs divided by a quantity of the second SSB beams used for scheduling (e.g., Scaling_factor_ue_per_ssb=max{1, floor((SSB,UE)-pair dwell time in unit of a quantity of SSBS/a quantity of beams to be used for scheduling)). The dwell time may be a filtered dwell time on a current SSB beam and UE beam pair (e.g., serving beam).

For undetected additional SSBs (e.g., in union of ssb_PositionInBurst (SIB1) and ssb_ToMeasure (SIB2) configured for SCell and NCell), estimated timing to conduct measurements and round-robin on layer 1 beams (L1 beams) may be used for coverage and for new network entity 105-a beam detection. In such examples, estimated timing may be used by using the serving cell (e.g., serving network entity 105-a beam) timing and an SSB lookup table (LUT) offset for each undetected SSB with respect to the detected cells (e.g., detected network entity beams 230). On each of undetected SSBs, the periodicity of SSB measurements may be based on the scaling factor per-UE 115-a and/or a scaling factor per network entity 105-a. The scaling factor may be a minimum value of a per-SSB UE scaling factor or a per-SSB network entity 105-a scaling factor based on a detection status of the one or more second SSBs being undetected SSBs. The per-SSB UE scaling factor may be equal to a minimum value of one or a value of a mathematical floor function of a dwell time associated with a respective SSB of the one or more second SSBs divided by a quantity of the second SSB beams. The dwell time may include a time in which the network entity 105-a communicates using the respective SSB (e.g., the scaling factor (e.g., scaling_factor_ue_per_ssb and scaling_factor_gnb_per_ssb) may be equal to a min (scaling_factor_ue_per_ssb,scaling_factor_gnb_per_ssb)*SSBS periodicity Scaling_factor_gnb_per_ssb'max{1, floor (SSB dwell time in unit of a quantity of SSBS/a quantity of L1 beams}). The SSB dwell time may be a filtered dwell time on current SSB beam as serving beam. Using the techniques discussed herein, for the detected or undetected SSBs, the UE 115-a may efficiently switch to measuring and communicating with the third beam 230-c and/or the fourth beam 230-d, as well switch to using the seventh beam 230-g and/or the eighth beam 230-h, for example, based on the target periodicity.

In some examples, the network entity 105-a may communicate with the UE 115-a using a communication link 125. In some examples, the communication link 125 may include a first channel 225-a for transmitting data from the UE 115-a to the network entity 105-a and a second channel 225-b for transmitting data from the network entity 105-a to the UE 115-a. The communication link 125 may be an example of an NR or LTE link between the UE 115-a and the network entity 105-a. The communication link 125 may include a bi-directional link that enables both uplink and downlink communications, for example, via the channels 225. For example, the UE 115-a may transmit uplink messages 245 (e.g., uplink transmissions), such as uplink control signals or uplink data signals, to the network entity 105-a using the first channel 225 a (e.g., of the communication link 125) and the network entity 105-a may transmit downlink messages 250 (e.g., downlink transmissions), such as downlink control signals or downlink data signals, to the UE 115-a using the second channel 225-b (e.g., of the communication link 125). In some examples, the downlink messages 250 may be part of control signaling transmitted from the network entity 105-a. In another example, the downlink messages 250 may include SSBs, for example, over the serving beam 230. The techniques described herein may also provide a balanced tradeoff between beam pair tracking and power saving at the UE 115-a and/or at the network entity 105-a.

The techniques described herein provide an efficient method to increase the searching for new network entity 105-a beams before entering the low SNR region (e.g., below an SNR threshold), for example. As an example, three network entity beams 230 may point to the UE 115-a, such as the first beam 230-a, the second beam 230-b, and the third beam 230-c. Two of the network entity beams 230, such as the first beam 230-a and the second beam 230-b, may be enabled and communicate with a power level that is not in a low SNR region. The power for the first beam 230-a may be adjusted so that the first beam 230-a has a greater power than the second beam 230-b, such as 5 dB greater power than the second beam 230-b, and the first beam 230-a may be the serving beam. The power for the remaining network entity beam 230, the third beam 230-c, may be set to the same power as the first beam 230-a, and at the same time, the power of the first beam 230-a may be reduced by 10 dB. A UE report may indicate that the third beams 230-c is quickly detected by the UE 115-a and becomes the serving beam 230.

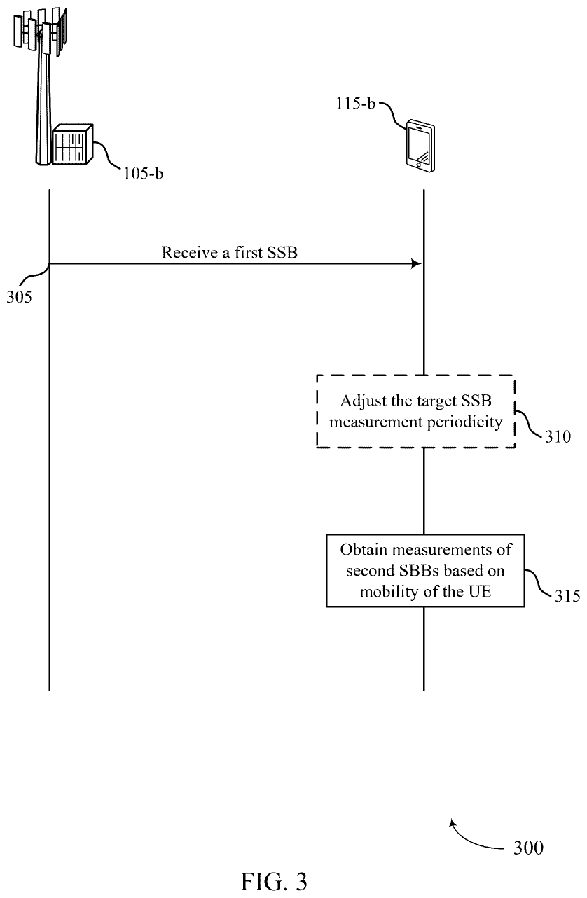

FIG. 3 shows an example of a process flow 300 that supports measurement sampling based on network entity mobility in accordance with one or more aspects of the present disclosure. The process flow 300 may implement aspects of or may be implemented by aspects of the wireless communications system 100 or the wireless communications system 200. For example, the process flow 300 may include a UE 115-b and a network entity 105-b, which may be an example of a UE 115 and a network entity 105 as described herein. In the following description of the process flow 300, the operations performed by the UE 115-b and the network entity 105b may be performed in different orders or at different times than the exemplary order shown. Some operations may also be omitted from the process flow 300, or other operations may be added to the process flow 300. Further, while operations in the process flow 300 are illustrated as being performed by the UE 115-b and the network entity 105b, the examples herein are not to be construed as limiting, as the described features may be associated with any quantity of different devices.

At 305, the UE 115-b (e.g., first network entity) may receive a first SSB from the network entity 105-b (e.g., second network entity), where the first SSB is received via a first SSB beam, and where communication between the UE 115-b and the network entity 105-b is based on the SSB. In some examples, the current SSB measurement periodicity may be estimated by the UE 115-b for undetected SSBs based on using a cell timing and a timing offset associated with each of the undetected one or more second SSBs.

In some examples, at 310, the UE 115-b may adjust the target SSB measurement periodicity based on a change in the mobility associated with the UE 115-b. The mobility may be associated with a scaling factor, and where the target SSB measurement periodicity is based on application of the scaling factor to a current SSB measurement periodicity. The UE 115-b may determine the scaling factor based on a detection status of the one or more second SSBs, where the detection status includes detected SSBs and undetected SSBs, and where the current SSB measurement periodicity is indicated to the UE 115-b for detected SSBs, and the current SSB measurement periodicity is estimated by the UE 115-b for undetected SSBs. The scaling factor may be a per-SSB UE scaling factor based on the detection status of the one or more second SSBs being detected SSBs. The per-SSB UE scaling factor may be equal to a maximum value of one or a value of a mathematical floor function of a dwell time associated with a respective SSB of the one or more second SSBs divided by a quantity of the second SSB beams used for scheduling, and where the dwell time includes a time in which the UE 115-b communicates using the respective SSB.

For undetected SSBs, the scaling factor may be a minimum value of a per-SSB UE scaling factor or a per-SSB network entity scaling factor based on a detection status of the one or more second SSBs being undetected SSBs. The per-SSB UE scaling factor may be equal to a minimum value of one or a value of a mathematical floor function of a dwell time associated with a respective SSB of the one or more second SSBs divided by a quantity of the second SSB beams, and where the dwell time includes a time in which the UE 115-a communicates using the respective SSB. The per-SSB network entity scaling factor may be equal to a maximum value of one or a value of a mathematical floor function of a dwell time associated with a respective SSB of the one or more second SSBs divided by a quantity of the second SSB beams, and where the dwell time comprises a time in which the UE 115-b communicates using the respective SSB.

At 315, the UE 115-b may obtain measurements of one or more second SSBs while the UE 115-b is in communication with the network entity 105-b, where the one or more second SSBs are received via respective second SSB beams, and where a target SSB measurement periodicity for collection of the measurements of the one or more second SSBs via the respective second SSB beams is based on a mobility associated with the UE 115-b.

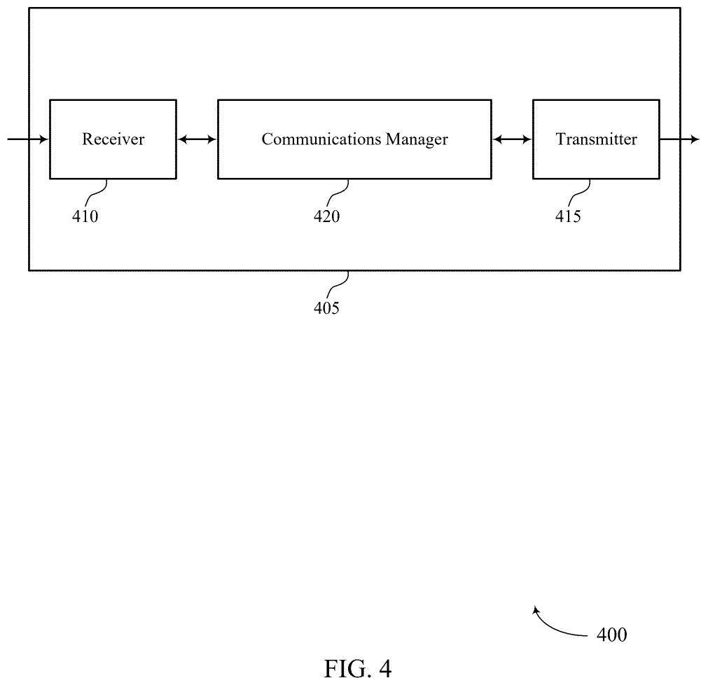

FIG. 4 shows a block diagram 400 of a device 405 that supports measurement sampling based on network entity mobility in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to measurement sampling based on network entity mobility). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to measurement sampling based on network entity mobility). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of measurement sampling based on network entity mobility as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication in accordance with examples as disclosed herein. For example, the communications manager 420 is capable of, configured to, or operable to support a means for receiving a first SSB from a second network entity, where the first SSB is received via a first SSB beam, and where communication between the first network entity and the second network entity is based on the SSB. The communications manager 420 is capable of, configured to, or operable to support a means for obtaining measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for determining SSB measurement periodicity based on mobility of the UE, resulting in efficient and more accurate determinations of communication quality between the UE and the network entity over the measured beams, reduced power consumption at the UE by reducing unnecessary measurement periods, or both.

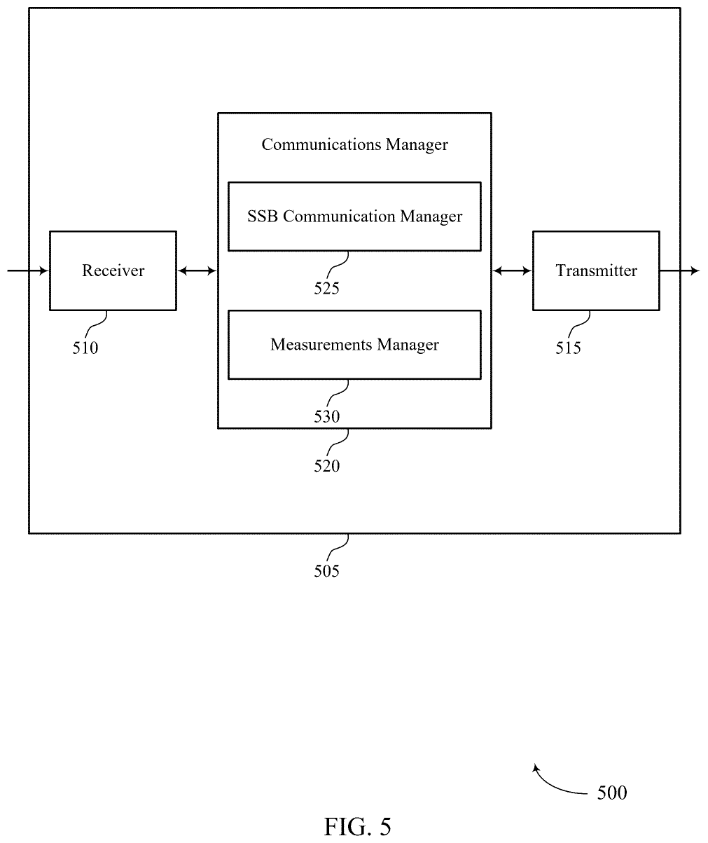

FIG. 5 shows a block diagram 500 of a device 505 that supports measurement sampling based on network entity mobility in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to measurement sampling based on network entity mobility). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to measurement sampling based on network entity mobility). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of measurement sampling based on network entity mobility as described herein. For example, the communications manager 520 may include an SSB communication manager 525 a measurements manager 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. The SSB communication manager 525 is capable of, configured to, or operable to support a means for receiving a first SSB from a second network entity, where the first SSB is received via a first SSB beam, and where communication between the first network entity and the second network entity is based on the SSB. The measurements manager 530 is capable of, configured to, or operable to support a means for obtaining measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity.

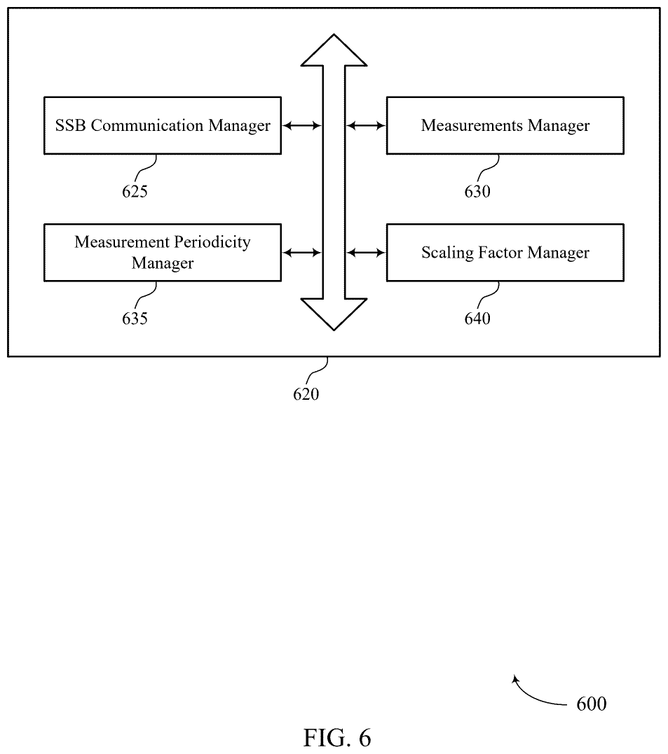

FIG. 6 shows a block diagram 600 of a communications manager 620 that supports measurement sampling based on network entity mobility in accordance with one or more aspects of the present disclosure. The communications manager 620 may be an example of aspects of a communications manager 420, a communications manager 520, or both, as described herein. The communications manager 620, or various components thereof, may be an example of means for performing various aspects of measurement sampling based on network entity mobility as described herein. For example, the communications manager 620 may include an SSB communication manager 625, a measurements manager 630, a measurement periodicity manager 635, a scaling factor manager 640, or any combination thereof. Each of these components, or components or subcomponents thereof (e.g., one or more processors, one or more memories), may communicate, directly or indirectly, with one another (e.g., via one or more buses).

The communications manager 620 may support wireless communication in accordance with examples as disclosed herein. The SSB communication manager 625 is capable of, configured to, or operable to support a means for receiving a first SSB from a second network entity, where the first SSB is received via a first SSB beam, and where communication between the first network entity and the second network entity is based on the SSB. The measurements manager 630 is capable of, configured to, or operable to support a means for obtaining measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity.

In some examples, the measurement periodicity manager 635 is capable of, configured to, or operable to support a means for adjust the target SSB measurement periodicity based on a change in the mobility associated with the first network entity.

In some examples, the mobility is associated with a scaling factor. In some examples, the target SSB measurement periodicity is based on application of the scaling factor to a current SSB measurement periodicity.

In some examples, the scaling factor manager 640 is capable of, configured to, or operable to support a means for determine the scaling factor based on a detection status of the one or more second SSBs, where the detection status includes detected SSBs and undetected SSBs, and where the current SSB measurement periodicity is indicated to the first network entity for detected SSBs, and the current SSB measurement periodicity is estimated by the first network entity for undetected SSBs.

In some examples, the scaling factor is a per-SSB UE scaling factor based on the detection status of the one or more second SSBs being detected SSBs.

In some examples, the per-SSB UE scaling factor is equal to a maximum value of one or a value of a mathematical floor function of a dwell time associated with a respective SSB of the one or more second SSBs divided by a quantity of the second SSB beams used for scheduling. In some examples, the dwell time includes a time in which the first network entity communicates using the respective SSB.

In some examples, the scaling factor is a minimum value of a per-SSB UE scaling factor or a per-SSB network entity scaling factor based on a detection status of the one or more second SSBs being undetected SSBs.

In some examples, the per-SSB UE scaling factor is equal to a minimum value of one or a value of a mathematical floor function of a dwell time associated with a respective SSB of the one or more second SSBs divided by a quantity of the second SSB beams. In some examples, the dwell time includes a time in which the first network entity communicates using the respective SSB.

In some examples, the per-SSB network entity scaling factor is equal to a maximum value of one or a value of a mathematical floor function of a dwell time associated with a respective SSB of the one or more second SSBs divided by a quantity of the second SSB beams. In some examples, the dwell time includes a time in which the first network entity communicates using the respective SSB.

In some examples, the current SSB measurement periodicity is estimated by the first network entity for undetected SSBs based on using a cell timing and a timing offset associated with each of the undetected one or more second SSBs.

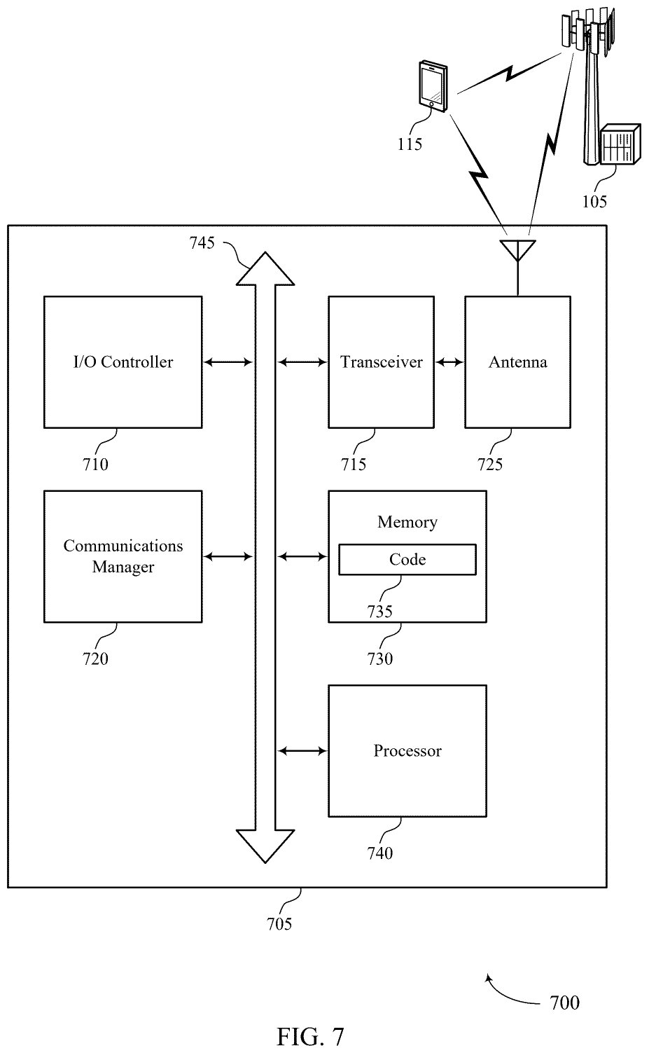

FIG. 7 shows a diagram of a system 700 including a device 705 that supports measurement sampling based on network entity mobility in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting measurement sampling based on network entity mobility). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communication in accordance with examples as disclosed herein. For example, the communications manager 720 is capable of, configured to, or operable to support a means for receiving a first SSB from a second network entity, where the first SSB is received via a first SSB beam, and where communication between the first network entity and the second network entity is based on the SSB. The communications manager 720 is capable of, configured to, or operable to support a means for obtaining measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity.

By including or configuring the communications manager 720 in accordance with examples as described herein, the device 705 may support techniques for determining SSB measurement periodicity based on mobility of the UE, resulting in efficient and more accurate determinations of communication quality between the UE and the network entity over the measured beams, reduced power consumption at the UE by reducing unnecessary measurement periods, or both.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of measurement sampling based on network entity mobility as described herein, or the at least one processor 740 and the at least one memory 730 may be otherwise configured to, individually or collectively, perform or support such operations.

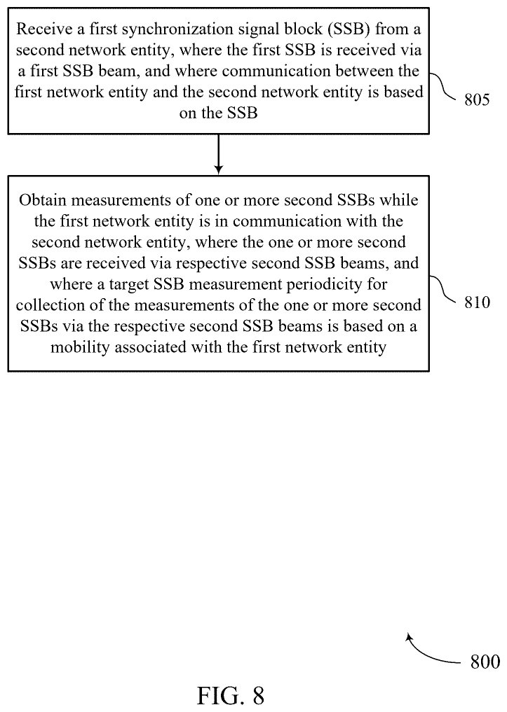

FIG. 8 shows a flowchart illustrating a method 800 that supports measurement sampling based on network entity mobility in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving a first SSB from a second network entity, where the first SSB is received via a first SSB beam, and where communication between the first network entity and the second network entity is based on the SSB. The operations of 805 may be performed in accordance with examples as disclosed herein. In some examples, aspects of the operations of 805 may be performed by an SSB communication manager 625 as described with reference to FIG. 6.

At 810, the method may include obtaining measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity. The operations of 810 may be performed in accordance with examples as disclosed herein. In some examples, aspects of the operations of 810 may be performed by a measurements manager 630 as described with reference to FIG. 6.

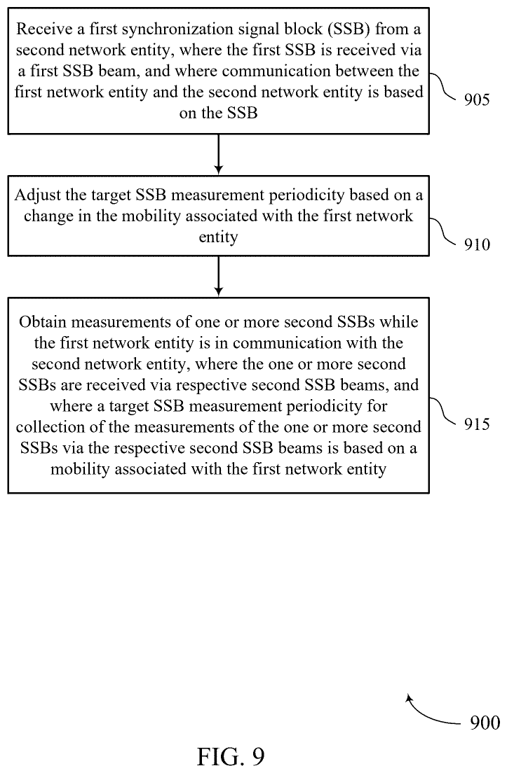

FIG. 9 shows a flowchart illustrating a method 900 that supports measurement sampling based on network entity mobility in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving a first SSB from a second network entity, where the first SSB is received via a first SSB beam, and where communication between the first network entity and the second network entity is based on the SSB. The operations of 905 may be performed in accordance with examples as disclosed herein. In some examples, aspects of the operations of 905 may be performed by an SSB communication manager 625 as described with reference to FIG. 6.

At 910, the method may include adjust the target SSB measurement periodicity based on a change in the mobility associated with the first network entity. The operations of 910 may be performed in accordance with examples as disclosed herein. In some examples, aspects of the operations of 910 may be performed by a measurement periodicity manager 635 as described with reference to FIG. 6.

At 915, the method may include obtaining measurements of one or more second SSBs while the first network entity is in communication with the second network entity, where the one or more second SSBs are received via respective second SSB beams, and where a target SSB measurement periodicity for collection of the measurements of the one or more second SSBs via the respective second SSB beams is based on a mobility associated with the first network entity. The operations of 915 may be performed in accordance with examples as disclosed herein. In some examples, aspects of the operations of 915 may be performed by a measurements manager 630 as described with reference to FIG. 6.

The following provides an overview of aspects of the present disclosure:

Aspect 1: A method for wireless communication at a first network entity, comprising: receiving a first SSB from a second network entity, wherein the first SSB is received via a first SSB beam, and wherein communication between the first network entity and the second network entity is based at least in part on the SSB; and obtaining measurements of one or more second SSBs while the first network entity is in communication with the second network entity, wherein the one or more second SSBs are received via respective second SSB beams, and wherein a target SSB measurement periodicity for collection of the measurements of the one or more second SSBs via the respective second SSB beams is based on a mobility associated with the first network entity.

Aspect 2: The method of aspect 1, further comprising: adjust the target SSB measurement periodicity based on a change in the mobility associated with the first network entity.

Aspect 3: The method of any of aspects 1 through 2, wherein the mobility is associated with a scaling factor, and the target SSB measurement periodicity is based on application of the scaling factor to a current SSB measurement periodicity.

Aspect 4: The method of aspect 3, further comprising: determine the scaling factor based on a detection status of the one or more second SSBs, wherein the detection status includes detected SSBs and undetected SSBs, and wherein the current SSB measurement periodicity is indicated to the first network entity for detected SSBs, and the current SSB measurement periodicity is estimated by the first network entity for undetected SSBs.

Aspect 5: The method of aspect 4, wherein the scaling factor is a per-SSB UE scaling factor based on the detection status of the one or more second SSBs being detected SSBs.

Aspect 6: The method of aspect 5, wherein the per-SSB UE scaling factor is equal to a maximum value of one or a value of a mathematical floor function of a dwell time associated with a respective SSB of the one or more second SSBs divided by a quantity of the second SSB beams used for scheduling, and the dwell time comprises a time in which the first network entity communicates using the respective SSB.

Aspect 7: The method of any of aspects 3 through 6, wherein the scaling factor is a minimum value of a per-SSB UE scaling factor or a per-SSB network entity scaling factor based on a detection status of the one or more second SSBs being undetected SSBs.

Aspect 8: The method of aspect 7, wherein the per-SSB UE scaling factor is equal to a minimum value of one or a value of a mathematical floor function of a dwell time associated with a respective SSB of the one or more second SSBs divided by a quantity of the second SSB beams, and the dwell time comprises a time in which the first network entity communicates using the respective SSB.

Aspect 9: The method of any of aspects 7 through 8, wherein the per-SSB network entity scaling factor is equal to a maximum value of one or a value of a mathematical floor function of a dwell time associated with a respective SSB of the one or more second SSBs divided by a quantity of the second SSB beams, and the dwell time comprises a time in which the first network entity communicates using the respective SSB.

Aspect 10: The method of any of aspects 3 through 9, wherein the current SSB measurement periodicity is estimated by the first network entity for undetected SSBs based on using a cell timing and a timing offset associated with each of the undetected one or more second SSBs.

Aspect 11: A first network entity for wireless communication, comprising one or more memories storing processor-executable code, and one or more processors coupled with the one or more memories and individually or collectively operable to execute the code to cause the first network entity to perform a method of any of aspects 1 through 10.

Aspect 12: A first network entity for wireless communication, comprising at least one means for performing a method of any of aspects 1 through 10.

Aspect 13: A non-transitory computer-readable medium storing code for wireless communication, the code comprising instructions executable by one or more processors to perform a method of any of aspects 1 through 10.

The methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
a processing system configured to:
receive a first synchronization signal block (SSB) from a second network entity, wherein the first SSB is received via a first SSB beam, and wherein communication between the first network entity and the second network entity is based on the SSB; and
obtain measurements of one or more second SSBs while the first network entity is in communication with the second network entity, wherein the one or more second SSBs are received via respective second SSB beams, and wherein a target SSB measurement periodicity for collection of the measurements of the one or more second SSBs via the respective second SSB beams is based on a mobility associated with the first network entity.

2. The first network entity of claim 1, wherein the processing system is configured to:
adjust the target SSB measurement periodicity based on a change in the mobility associated with the first network entity.

3. The first network entity of claim 1, wherein:
the mobility is associated with a scaling factor, and
the target SSB measurement periodicity is based on application of the scaling factor to a current SSB measurement periodicity.

4. The first network entity of claim 3, wherein the processing system is configured to:
determine the scaling factor based on a detection status of the one or more second SSBs, wherein the detection status includes detected SSBs and undetected SSBs, and wherein the current SSB measurement periodicity is indicated to the first network entity for detected SSBs, and the current SSB measurement periodicity is estimated by the first network entity for undetected SSBs.

5. The first network entity of claim 4, wherein the scaling factor is a per-SSB user equipment (UE) scaling factor based on the detection status of the one or more second SSBs being detected SSBs.

6. The first network entity of claim 5, wherein:
the per-SSB UE scaling factor is equal to a maximum value of one or a value of a mathematical floor function of a dwell time associated with a respective SSB of the one or more second SSBs divided by a quantity of the respective second SSB beams used for scheduling, and
the dwell time comprises a time in which the first network entity communicates using the respective SSB.

7. The first network entity of claim 3, wherein the scaling factor is a minimum value of a per-SSB user equipment (UE) scaling factor or a per-SSB network entity scaling factor based on a detection status of the one or more second SSBs being undetected SSBs.

8. The first network entity of claim 7, wherein:
the per-SSB UE scaling factor is equal to a minimum value of one or a value of a mathematical floor function of a dwell time associated with a respective SSB of the one or more second SSBs divided by a quantity of the respective second SSB beams, and
the dwell time comprises a time in which the first network entity communicates using the respective SSB.

9. The first network entity of claim 7, wherein:
the per-SSB network entity scaling factor is equal to a maximum value of one or a value of a mathematical floor function of a dwell time associated with a respective SSB of the one or more second SSBs divided by a quantity of the respective second SSB beams, and
the dwell time comprises a time in which the first network entity communicates using the respective SSB.

10. The first network entity of claim 3, wherein the current SSB measurement periodicity is estimated by the first network entity for undetected one or more second SSBs based on using a cell timing and a timing offset associated with each of the undetected one or more second SSBs.

11. A method of wireless communication performed by a first network entity, comprising:
receiving a first synchronization signal block (SSB) from a second network entity, wherein the first SSB is received via a first SSB beam, and wherein communication between the first network entity and the second network entity is based on the SSB; and
obtaining measurements of one or more second SSBs while the first network entity is in communication with the second network entity, wherein the one or more second SSBs are received via respective second SSB beams, and wherein a target SSB measurement periodicity for collection of the measurements of the one or more second SSBs via the respective second SSB beams is based on a mobility associated with the first network entity.

12. The method of claim 11, further comprising:
adjusting the target SSB measurement periodicity based on a change in the mobility associated with the first network entity.

13. The method of claim 11, wherein:
the mobility is associated with a scaling factor, and
the target SSB measurement periodicity is based on application of the scaling factor to a current SSB measurement periodicity.

14. The method of claim 13, further comprising:
determining the scaling factor based on a detection status of the one or more second SSBs, wherein the detection status includes detected SSBs and undetected SSBs, and wherein the current SSB measurement periodicity is indicated to the first network entity for detected SSBs, and the current SSB measurement periodicity is estimated by the first network entity for undetected SSBs.

15. The method of claim 14, wherein the scaling factor is a per-SSB user equipment (UE) scaling factor based on the detection status of the one or more second SSBs being detected SSBs.

16. The method of claim 15, wherein:
the per-SSB UE scaling factor is equal to a maximum value of one or a value of a mathematical floor function of a dwell time associated with a respective SSB of the one or more second SSBs divided by a quantity of the respective second SSB beams used for scheduling, and
the dwell time comprises a time in which the first network entity communicates using the respective SSB.

17. The method of claim 13, wherein the scaling factor is a minimum value of a per-SSB user equipment (UE) scaling factor or a per-SSB network entity scaling factor based on a detection status of the one or more second SSBs being undetected SSBs.

18. The method of claim 17, wherein:
the per-SSB UE scaling factor is equal to a minimum value of one or a value of a mathematical floor function of a dwell time associated with a respective SSB of the one or more second SSBs divided by a quantity of the respective second SSB beams, and
the dwell time comprises a time in which the first network entity communicates using the respective SSB.

19. The method of claim 17, wherein:
the per-SSB network entity scaling factor is equal to a maximum value of one or a value of a mathematical floor function of a dwell time associated with a respective SSB of the one or more second SSBs divided by a quantity of the respective second SSB beams, and
the dwell time comprises a time in which the first network entity communicates using the respective SSB.

20. A non-transitory computer-readable medium having code for wireless communication stored thereon that, when executed by a first network entity, causes the first network entity to:
receive a first synchronization signal block (SSB) from a second network entity, wherein the first SSB is received via a first SSB beam, and wherein communication between the first network entity and the second network entity is based on the SSB; and
obtain measurements of one or more second SSBs while the first network entity is in communication with the second network entity, wherein the one or more second SSBs are received via respective second SSB beams, and wherein a target SSB measurement periodicity for collection of the measurements of the one or more second SSBs via the respective second SSB beams is based on a mobility associated with the first network entity.
